(19) United States
(12) Patent Application Publication
(10) Pub. No.: US 2024/0288879 A1
(43) Pub. Date: Aug. 29, 2024

(54) SPRAYING OPERATION PLANNING METHOD AND DEVICE, CONTROL TERMINAL, AND STORAGE MEDIUM

(71) Applicant: SZ DJI TECHNOLOGY CO., LTD., Shenzhen (CN)

(72) Inventors: Lu WANG, Shenzhen (CN); Xianghua JIA, Shenzhen (CN); Zhenchu LI, Shenzhen (CN)

(73) Assignee: SZ DJI TECHNOLOGY CO., LTD., Shenzhen (CN)

(21) Appl. No.: 18/660,204

(22) Filed: May 9, 2024

Related U.S. Application Data
(63) Continuation of application No. PCT/CN2021/129843, filed on Nov. 10, 2021.

(51) Int. Cl. G05D 1/646; A01M 7/00; B64U 10/00; B64U 101/45

(52) U.S. Cl. CPC G05D 1/646; A01M 7/0089; B64U 10/00; B64U 2101/45

(57) ABSTRACT

A method and device for planning spraying operations, a control terminal and storage medium are provided. The method includes: obtaining and displaying a flight route of a UAV, and controlling the UAV to execute a spraying operation along the flight route, where the flight route includes a plurality of segments including spraying segments and non-spraying segments; obtaining an interruption position of an interruption segment; based on a position of the UAV, determining whether there exists a projection position within the first preset number of spraying segments that have not been executed after the interruption segment without determining whether there exists a projection position of the UAV within the non-spraying segments; and displaying indicator(s) to indicate the position of the return position(s) on the flight route. The present disclosure can meet the user's expectations and conserves electrical energy consumption, thereby improving the efficiency of executing spraying operations.

### RELATED APPLICATIONS

This application is a continuation application of PCT application No. PCT/CN2021/129843, filed on Nov. 10, 2021, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of agricultural operation technology, especially to a spraying operation planning method and device, a control terminal, and a storage medium.

### BACKGROUND

In the existing technology, a control terminal can automatically plan the route for executing spraying operations. It can send the planned route to an unmanned aerial vehicle (UAV), enabling the UAV to carry out spraying operations along the planned route. In practical applications, due to limitations such as the load capacity of the UAV, the battery capacity, or obstacles encountered along the route, the UAV may need to deviate from the planned route to reach a replenishment point for refilling, battery replacement, or obstacle avoidance. After completing these tasks, the UAV needs to determine a return point on the route. It can then fly to a return point and continue along the route from there to carry out spraying operations.

However, in the existing technology, the strategy for determining return points on the route is not intelligent, and the logic for determining return points does not meet user expectations. For example, in the existing technology, the determined return points may include projecting the UAV's position onto the unexecuted segments of the route following the segment where the UAV's operation was interrupted. These unexecuted segments may include non-spraying segments, and the return points may include the projection points of the UAV on these non-spraying segments. However, during actual spraying operations, using projection points on non-spraying segments as return points and directing the UAV back to these points not only fails to meet user expectations but also wastes the UAV's battery power, leading to inefficient spraying operations.

### SUMMARY

Embodiments of the present disclosure provide a spraying operation planning method and device, a control terminal, and a storage medium to meet user expectations and improve the efficiency of UAV spraying operations.

In one aspect, embodiments of the present disclosure provide a method for operation planning, including: displaying a path of a movable object, where the path includes a plurality of segments, and the plurality of segments includes operation segments for the movable object and non-operation segments for the movable object; determining an interruption position in an interruption segment where the operation of the movable object is interrupted; determining, based on a position of the movable object, whether the movable object has a projection position corresponding to the position of the movable object in at least one of the interruption segment or each operation segment of a first preset number of operation segments that come after the interruption segment and have not yet been performed with the operation; and displaying, on the path, indicators indicating return positions for the movable object, where the return positions include at least one of the interruption position, or the projection position.

In another aspect, embodiments of the present disclosure provide a device for operation planning, including: at least one storage medium storing at least one set of instructions for operation planning; and at least one processor in communication with the at least one storage medium, where during operation, the at least one processor executes the at least one set of instructions to cause the device to at least: display a path of a movable object, where the path includes a plurality of segments, and the plurality of segments includes operation segments for the movable object and non-operation segments for the movable object, determine an interruption position in an interruption segment where the operation of the movable object is interrupted, determine, based on a position of the movable object, whether the movable object has a projection position corresponding to the position of the movable object in at least one of the interruption segment or each operation segment of a first preset number of operation segments that come after the interruption segment and have not yet been performed with the operation, and display, on the path, indicators indicating return positions for the movable object, where the return positions include at least one of the interruption position, or the projection position.

By adopting the present disclosure, in the process of determining return points, it can avoid planning return points on non-spraying segments based on the spraying attributes of the segments following the interruption segment. Except for the interruption point and projection points (if any) in the interruption segment, all return points are planned on spraying segments. This reduces the probability of controlling the UAV to return to non-spraying segments, aligning with user expectations and saving energy consumption, thus enhancing the efficiency of executing spraying operations.

### BRIEF DESCRIPTION OF THE DRAWINGS

In order to clearly illustrate the technical solutions of the embodiments of the present disclosure, the following will briefly introduce the drawings for the description of some exemplary embodiments. Apparently, the accompanying drawings in the following description are some exemplary embodiments of the present disclosure. For a person of ordinary skill in the art, other drawings may also be obtained based on these drawings without creative efforts.

FIG. 1 is a schematic diagram of a planning process for spraying operations according to some embodiments of the present disclosure;

FIG. 2 to FIG. 8 are schematic diagrams illustrating the determination of return points for a UAV provided in different situations after deviating from a flight route according to some embodiments of the present disclosure;

FIG. 9 is schematic diagram of the structure of a planning device for spraying operations according to some embodiments of the present disclosure; and

FIG. 10 is a schematic diagram of the structure of a control terminal provided according to some embodiments of the present disclosure.

### DETAILED DESCRIPTION

To clarify the purpose, technical solutions, and advantages of the embodiments of the present disclosure, the following description will refer to the accompanying drawings of the embodiments of the present disclosure to provide a clear full description of the technical solutions. It is evident that the described exemplary embodiments are part of the embodiments of the present disclosure and not all embodiments. Based on the embodiments of the present disclosure, all other embodiments obtained by a person of ordinary skill in the art without inventive efforts fall within the scope of protection of the present disclosure.

The terminology used in the embodiments of the present disclosure is solely for the purpose of describing particular embodiments and is not intended to limit the present disclosure. The singular forms “a,” “an,” and “the” used in the embodiments of the present disclosure and in the appended claims are also intended to encompass plural forms, unless the context clearly indicates otherwise. “Multiple/a plurality of” generally includes at least two.

Depending on the context, words such as “if” and “when” used herein can be interpreted to mean “at the time of,” “upon determination,” or “in response to detection.” Similarly, phrases such as “if determined” or “if detected (stated condition or event)” can be interpreted to mean “when determined” or “upon determination,” or “when detected (stated condition or event)” or “in response to detection (stated condition or event)” depending on the context.

Additionally, the sequence of steps in the following method embodiments is provided as an example and is not strictly limiting.

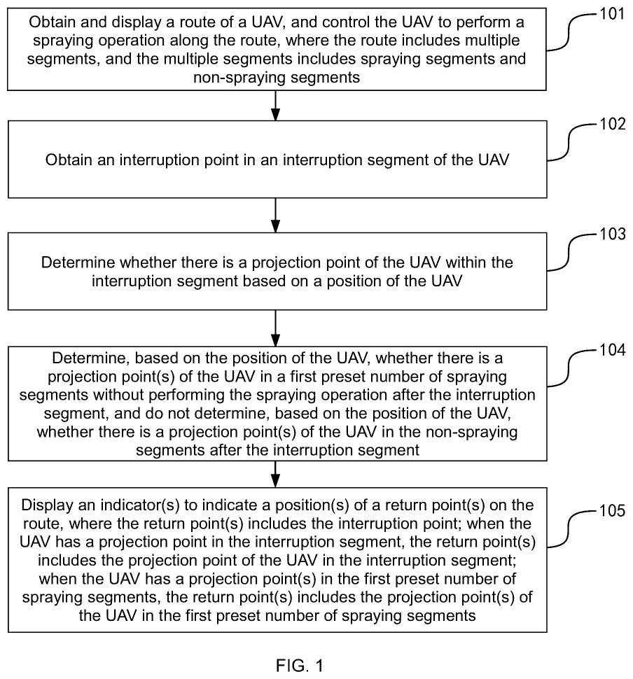

FIG. 1 is a schematic diagram of a planning process for spraying operations according to some embodiments of the present disclosure. The executing entity of the method can be a planning device for spraying operations. In some exemplary embodiments, the control terminal may include the planning device, and the method can be applied to the control terminal, that is, the method can be executed by the control terminal. The following diagrammatic illustration is conducted by the control terminal as the executing entity. As shown in FIG. 1, the method includes the following steps:
101. Obtain and display a route of a UAV, and control the UAV to perform a spraying operation along the route, where the route includes multiple segments, and the multiple segments includes spraying segments and non-spraying segments.
102. Obtain an interruption point in an interruption segment of the UAV.
103. Determine whether there is a projection point of the UAV within the interruption segment based on a position of the UAV.
104. Determine, based on the position of the UAV, whether there is a projection point(s) of the UAV in a first preset number of spraying segments without performing the spraying operation after the interruption segment, and do not determine, based on the position of the UAV, whether there is a projection point(s) of the UAV in the non-spraying segments after the interruption segment.
105. Display an indicator(s) to indicate a position(s) of a return point(s) on the route, where the return point(s) includes the interruption point; when the UAV has a projection point in the interruption segment, the return point(s) includes the projection point of the UAV in the interruption segment; when the UAV has a projection point(s) in the first preset number of spraying segments, the return point(s) includes the projection point(s) of the UAV in the first preset number of spraying segments.

In practical applications, users can input the area where spraying operations are needed into the control terminal. The control terminal, in response to the selection of the operating area, determines the UAV's operation area. The control terminal may include a display device, which can show maps for delineating the operational area. This allows users to select the area(s) where spraying operations are needed directly on the map. Subsequently, the control terminal can automatically plan the route for executing the spraying operation based on the user-selected operation area. The control terminal establishes a bidirectional communication link with the UAV, enabling it to transmit the planned flight route to the UAV. Consequently, the UAV can execute the spraying operation along the planned route. Additionally, users can manually control the UAV via the control terminal. The control terminal can display the planned flight route on the display device, facilitating users in observing the UAV's spraying operation. The display device can be a screen, and in some cases, it can be a touchscreen display. It is noted that the route herein is merely an example, and the present disclosure covers any type of path, including a route.

The control terminal can obtain the position of the UAV, optionally obtaining it according to a preset interval/period. The UAV sends its position to the control terminal, which then marks the UAV's position on the flight route, facilitating users in viewing the UAV's real-time location. Additionally, the control terminal can obtain the interruption point of the UAV's interruption segment, i.e., obtaining the position of the interruption point. This position can be obtained from the UAV's transmission to the control terminal.

In practical applications, due to limitations such as the amount of pesticide/reagent the UAV can carry, the battery capacity, or encountering obstacles along the flight route, the UAV may need to deviate from the planned flight route to reach a replenishment location for refilling pesticide/reagent, changing batteries, or avoiding obstacles. After the UAV completes the refilling, battery change, or obstacle avoidance, it needs to determine a return point on the flight route. The UAV can fly to this return point and continue along the flight route from there to execute the spraying operation. The methods provided in some exemplary embodiments of the present disclosure can plan the return point for the UAV when it returns to the flight route.

In some exemplary embodiments of the present disclosure, the flight route can be divided into multiple segments, which may include spraying segments and non-spraying segments. Spraying segments are those where spraying operations are required, while non-spraying segments are those where spraying operations are not required. In some cases, within these multiple segments, the spraying segments and non-spraying segments are alternately connected. In some exemplary embodiments, the spraying segments are parallel to each other, while in others, the non-spraying segments are parallel to each other.

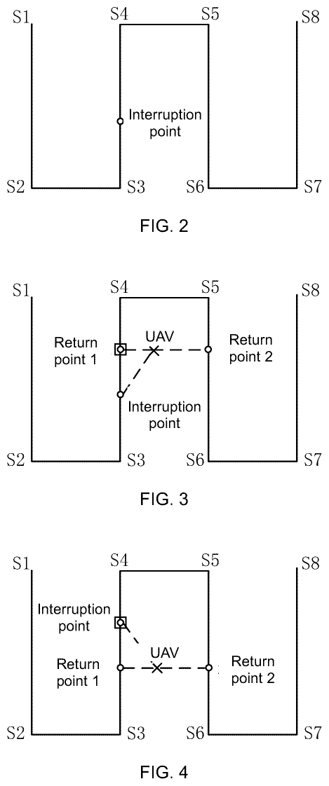

For example, as shown in FIG. 2, the flight route can include segments S1S2, S2S3, S3S4, S4S5, S5S6, S6S7, and S7S8. Among them, S1S2 represents spraying segments, S2S3 represents non-spraying segments, S3S4 represents spraying segments, S4S5 represents non-spraying segments, S5S6 represents spraying segments, S6S7 represents non-spraying segments, and S7S8 represents spraying segments.

In practical applications, the location where the UAV deviates from the flight route can be referred to as the interruption point, and the segment of the flight route where the interruption point is located can be referred to as the interruption segment. Continuing with the example in FIG. 2, if the UAV deviates from the flight route at the interruption point shown in the figure, the interruption segment would be S3S4.

After the UAV deviates from the flight route, it may continue flying at a certain speed. When the UAV reaches a certain position, its speed may decrease to below a threshold or to zero. At this point, the UAV's position can be obtained, and based on this position, it can be determined whether the UAV has a projection point within the interruption segment. The process of determining the projection point can be implemented as follows: by determining whether there is a perpendicular line from the UAV to the interruption segment. If such a perpendicular line exists, the foot of the perpendicular is considered the projection point of the UAV within the interruption segment. This projection point can serve as a return point for the UAV to return to the flight route.

It's understandable that there's a sequence in which the UAV flies through multiple flight segments, and the UAV needs to fly through each segment in order. Taking FIG. 2 as an example, the sequence of flight segments that the UAV needs to fly through in order is: S1S2, S2S3, S3S4, S4S5, S5S6, S6S7, S7S8.

Based on this, it's also possible to determine the first preset number of spraying segments that are located after the interruption segment and have not yet executed the spraying operation. The first preset number of spraying segments refers to the spraying segments close to the interruption segment in the direction of the flight route. Continuing with the example in FIG. 2, the spraying segments that have not yet executed the spraying operation after the interruption segment include S5S6 and S7S8. In some exemplary embodiments, the first preset number can be a value greater than or equal to 2. It can be determined whether there is a projection point in these segments. If the projection point exists, it can be considered as the return point for the UAV to return to the flight route.

Additionally, it's worth noting that there's no need to determine the projection point of the UAV in the non-spraying segments. As shown in FIG. 2, there's no need to determine the projection point of the UAV in S4S5 and S6S7. This is because even if there are projection point of the UAV in certain non-spraying segments, it's not recommended to use it as the return point since the UAV does not need to execute the spraying operation in the non-spraying segments. Using a projection point in the non-spraying segments as the return point might lead the UAV to return to this point and then fly along the non-spraying segments to reach the next spraying segment, which could increase the UAV's flight distance and energy consumption. If the UAV can directly return to a return point located in a spraying segment, it can shorten the UAV's flight distance and reduce energy consumption.

It's important to note that the interruption point can also serve as a return point for the UAV to return to the flight route. After determining all the return points, the control terminal can display indicators indicating the positions of these return points on the flight route. However, the return points do not include projection points of the UAV in non-spraying segments after the interruption segment.

It's worth mentioning that the return points for the UAV's return to the flight route can be updated based on the UAV's real-time position according to a preset interval/period. When the UAV's position changes, the process described above can be repeated to determine possible return points based on the UAV's latest position.

Moreover, for user convenience and clarity, the control terminal can directly display the words “RETURN POINT” at the corresponding positions of the return points on the flight route. This may help users easily understand that the marked points on the flight route indicate possible return locations for the UAV.

In some exemplary embodiments, if the UAV has a projection point in the interruption segment and there is a projection point on each segment of the first preset number of spraying segments, the return points may include a second preset number of projection points close to the interruption point among the first preset number of projection points. The return points may exclude any projection points other than the second preset number of projection points from the first preset number of projection points; and/or if the UAV does not have a projection point in the interruption segment and there is a projection point on each segment of the first preset number of spraying segments, the return points can include all the projection points of the first preset number.

It's important to note that when the UAV has a projection point in the interruption segment and there is a projection point on each segment of the first preset number of spraying segments, there might be multiple optional return points. In such cases, it's sufficient to display only the second preset number of projection points close to the interruption point among the first preset number of projection points. By utilizing the methods provided in the embodiments of the present disclosure, the number of return points can be optimized and limited to a certain value, facilitating user selection.

In some exemplary embodiments, the first preset number can be 2, and the second preset number can be 1. Taking FIG. 3 as an example, where the spraying attributes of each segment are the same as in FIG. 2, the projection point of the UAV on S3S4 serves as return point 1, and the projection point on S5S6 serves as return point 2. Although there is also a projection point on S7S8, only one projection point close to the interruption point is displayed, so the projection point on S7S8 can be omitted. The final display would include the interruption point, return point 1, and return point 2.

In the example above, the projection point of the UAV on S7S8 is far from the interruption point, and typical users are unlikely to choose such a projection point as a return point. If all the projection points of the first preset number are displayed on the control terminal, it may cause confusion for users' selection. Therefore, to improve efficiency in selection, the projection point on S7S8 can be omitted from display.

The second preset number of projection points close to the interruption point among the first preset number of projection points may be determined based on the distance along the flight route. For example, in FIG. 3, the distance from return point 2 to the interruption point is the sum of the distance from return point 2 to S5, the distance from S4S5, and the distance from S4 to the interruption point.

Taking FIG. 4 as another example, where the spraying attributes of each segment are the same as in FIG. 2, it is assumed that during the spraying operation, the UAV detects insufficient pesticide or battery power and needs to deviate from the flight route to replenish them. In this case, as shown in FIG. 4, the user pulls the UAV off the flight route from the interruption point in the opposite direction of operation to reach the stopping position indicated in the figure. In such a scenario, possible return points can include the interruption point, return point 1 obtained from the projection of the UAV on S3S4, and return point 2 obtained from the projection of the UAV on S5S6.

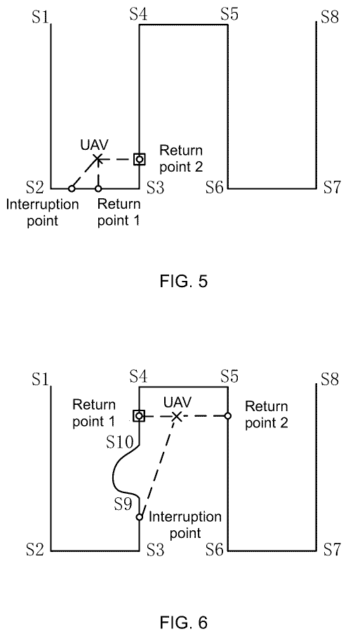

Next taking FIG. 5 as another example, where the spraying attributes of each segment are the same as in FIG. 2. Possible return points can include the interruption point, return point 1 obtained from the projection of the UAV in the interruption segment S2S3, and return point 2 obtained from the projection of the UAV on S3S4.

When the UAV does not have a projection point in the interruption segment and there is a projection point on each segment of the first preset number of spraying segments, all the projection points of the first preset number can be displayed. Since the UAV does not have a projection point in the interruption segment, users have one less option for return points. To provide users with ample choices, all the projection points of the first preset number can be displayed for user selection.

Taking FIG. 6 as another example, where the UAV does not have a projection point in the interruption segment S3S9, and the segment S9S10 is an obstacle avoidance segment. For instance, there may be utility poles near S9S10, and to avoid them, the UAV needs to plan an obstacle avoidance segment to fly around the poles. If the user does not instruct the UAV to fly along the obstacle avoidance segment but manually pulls the UAV off the flight route from the interruption point as shown in the figure, possible return points can include the interruption point shown in the figure, return point 1 obtained from the projection of the UAV on S10S4, and return point 2 obtained from the projection of the UAV on S5S6.

In some exemplary embodiments, when the UAV does not have a projection point in the interruption segment and there is no projection point on any segment of the first preset number of spraying segments, the return points include the starting point of the first spraying segment among the first preset number of spraying segments.

The first spraying segment among the aforementioned first preset number of spraying segments is determined based on the sequence of flight between the multiple flight segments mentioned earlier.

It's worth noting that when the UAV flies out of the designated area, and there are no projection points in the interruption segment or any segment of the first preset number of spraying segments, it's important to ensure there are return points available for user selection. To avoid leaving the user with no return points to choose from, the starting point of the first spraying segment in the first preset number of spraying segments can be used as a return point.

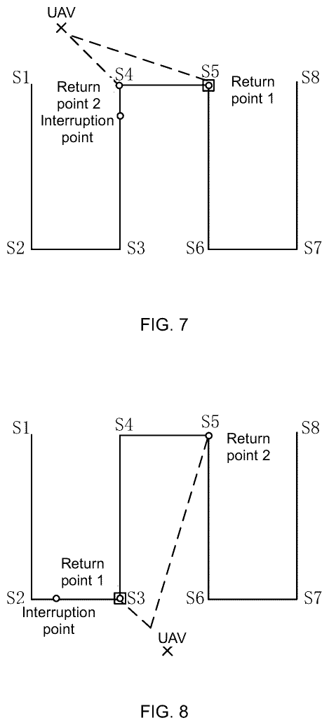

Taking FIG. 7 as an example, where the spraying attributes of each segment are the same as in FIG. 2, when the UAV flies out of the designated area and there are no projection points in S3S4, S5S6, and S7S8, the starting point S5 of the first spraying segment S5S6 of S5S6 and S7S8 can be determined as return point 1.

In some exemplary embodiments, if the interruption segment is a spraying segment, the return points include the end point of the interruption segment; and/or, if the interruption segment is a non-spraying segment, the return points include the starting point of the second spraying segment of the first preset number of spraying segments.

Continuing with FIG. 7, where the interruption segment S3S4 is a spraying segment, the end point S4 of S3S4 can be determined as return point 2.

If the interruption segment is a non-spraying segment, the starting point of the second spraying segment of the first preset number of spraying segments can also be determined as a return point. Continuing with FIG. 8 as an example, where the interruption segment S2S3 is a non-spraying segment, possible return points can include the interruption point, the starting point S3 of the first spraying segment S3S4 as return point 1, and the starting point S5 of the second spraying segment S5S6 as return point 2.

In some exemplary embodiments, the methods provided in the embodiments of the present disclosure can also include: detecting a user's selection of the return points, determining a target return point selected by the user based on a detected selection operation, controlling the UAV to fly to the target return point, and controlling the UAV to continue the spraying operation along the route from the target return point.

In situations where the UAV may be in a low-speed flight state or stationary outside the flight route, the options corresponding to each determined return point can be displayed on one side of the display device of the control terminal. This allows users to select the target return point from the options presented.

Using the above method, a certain number of return points can be determined for user selection. Furthermore, after the UAV is stopped, recommended return points can be determined from the available return points. Indicators showing the positions of these recommended return points on the flight route can be displayed. This allows users to use the recommended return points directly without the need for manual selection, simplifying the operation for users. Additionally, it can reduce unnecessary flight time for the UAV, saving energy consumption, and improving the efficiency of spraying operations.

In some exemplary embodiments, the recommended return point can be preselected by default. As long as the user confirms to return to this recommended return point, the UAV can be directly controlled to fly to it and return to the flight route. The recommended return point can be distinguished from other return points by specific indicators. For example, while other return points can be marked with circled selections, the recommended return points can be marked with square selections. This way, users can easily identify which locations along the flight route are optional return points and which one is the recommended return point.

In some exemplary embodiments, the process of determining the recommended return point from the available return points can be implemented as follows: if the UAV has a projection point in the interruption segment, the recommended return point can be determined from the projection point and the interruption point.

In some exemplary embodiments, the process of determining the recommended return point from the projection point and interruption point can be implemented as follows: based on the distances between the interruption point and the end point of the interruption segment, and between the projection point and the end point of the interruption segment, the recommended return point can be determined from the projection point and interruption point.

In some exemplary embodiments, the process of determining the recommended return point from the projection point and the interruption point based on the distance between the interruption point and the end point of the interruption segment, and the distance between the projection point and the end point of the interruption segment can be achieved as follows: if the distance between the interruption point and the end point of the interruption segment is greater than the distance between any projection point and the end point of the interruption segment, and the distance between any projection point and the end point of the interruption segment is greater than a preset threshold, that particular projection point is determined as the recommended return point; and/or if the distance between the interruption point and the end point of the interruption segment is less than the distance between each projection point and the end point of the interruption segment, the interruption point is determined as the recommended return point.

For example, as shown in FIG. 3, the return points include the interruption point, return point 1, and return point 2. In this case, the distance between the interruption point and the end point of the interruption segment, S4, is greater than the distance between return point 1 and S4. Assuming that at the same time the distance between return point 1 and S4 is greater than a preset threshold, it can be determined that return point 1 as the recommended return point.

It's worth noting that when the user deviates the UAV from the interruption point towards the direction of executing the spraying operation, if the distance between the interruption point and the end point of the interruption segment is greater than the distance between return point 1 and the end point of the interruption segment, it typically indicates a potential obstacle between the interruption point and return point 1. Therefore, it is no longer recommended to control the UAV to return to the interruption point but instead to recommend controlling the UAV to fly to return point 1. Additionally, since return point 2 is farther from S4, it is not recommended to fly to return point 2.

It's worth noting that the condition for recommending return point 1 includes that the distance between return point 1 and the end point of the interruption segment is greater than the preset threshold. This indicates that there is still a portion of the interruption segment where spraying operations can be performed, so it's necessary to complete spraying in that portion of the segment. However, if the distance between return point 1 and the end point of the interruption segment is less than the preset threshold, it indicates that there isn't much area left in the interruption segment where spraying operations can be performed. In this case, it's possible to skip the interruption segment entirely and recommend controlling the UAV to fly to return point 2 located on the next spraying segment.

For example, as shown in FIG. 4, the distance between the interruption point and the end point of the interruption segment, S4, is less than the distance between return point 1 and S4, and it is also less than the distance between return point 2 and S4. In this case, it is recommended to use the interruption point as the recommended return point.

It's important to note that when the user pulls the UAV away from the flight route in the opposite direction of the spraying operation from the interruption point, if the distance between the interruption point and the end point of the interruption segment is less than the distance(s) between return point 1, return point 2, and the end point of the interruption segment, it typically indicates that the UAV at the interruption point may have insufficient pesticide or battery power. Therefore, flying back to the current position to replenish pesticide or battery power is recommended, and thus it's recommended for the UAV to return to the interruption point to continue the spraying operation.

In some exemplary embodiments, when there are no projection points within the interruption segment and there are no projection points within the first preset number of spraying segments, the return points include the starting point of the first spraying segment among the first preset number of spraying segments. Accordingly, the process of determining the recommended return point from the return points can be implemented as follows: determining the starting point of the first spraying segment as the recommended return point.

As shown in FIG. 7, where the starting point of the first spraying segment is S5, it is recommended to control the UAV to fly to return point 1.

As shown in FIG. 8, where the starting point of the first spraying segment is S3, it is recommended to control the UAV to fly to return point 1.

In some exemplary embodiments, the process of determining the recommended return point from the return points can be implemented as follows: when there are no projection points within the interruption segment and there are projection points within the first preset number of spraying segments, selecting the projection point closest to the interruption point from the projection points and determining it as the recommended return point.

As shown in FIG. 6, there are no projection points in the segment S3S9, and there are projection points on both segments S10S4 and S5S6. The return point 1 obtained from the projection on segment S10S4 is closer to the interruption point. Therefore, it is recommended to control the UAV to fly to return point 1.

Additionally, it is not recommended to consider return points located on non-spraying segments as the recommended return point. Therefore, for the situation depicted in FIG. 5, return point 2 is recommended as the recommended return point.

Using the approach described in the present disclosure, multiple return points can be determined for the user to choose from. This approach offers greater flexibility compared to the strategy in related technologies, which involves directly generating a single projection point and controlling the UAV to return to that projection point. In the process of determining return points, the present disclosure considers the spraying attributes of flight segments and avoids planning return points on non-spraying segments. Apart from the interruption point and any projection points on the interruption segment (if present), all return points are planned on spraying segments. This approach reduces the likelihood of controlling the UAV to return to non-spraying segments, thereby shortening the UAV's flight distance, conserving battery power, and enhancing the efficiency of spraying operations.

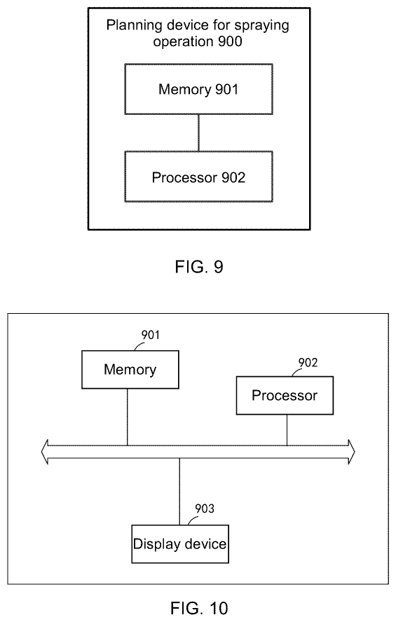

Some exemplary embodiments of the present disclosure further provides a planning device for spraying operations, as illustrated in FIG. 9. The device may include:

At least one memory/storage medium 901, for storing computer a program(s);

At least one processor 902, for executing the computer program(s) stored in the at least one memory/storage medium 901 to achieve:

Obtain and display a route of a UAV, and control the UAV to perform a spraying operation along the route, where the route includes multiple segments, and the multiple segments includes spraying segments and non-spraying segments. Obtain an interruption point in an interruption segment of the UAV.

Determine whether there is a projection point of the UAV within the interruption segment based on a position of the UAV.

Determine, based on the position of the UAV, whether there is a projection point(s) of the UAV in a first preset number of spraying segments without performing the spraying operation after the interruption segment, and do not determine, based on the position of the UAV, whether there is a projection point(s) of the UAV in the non-spraying segments after the interruption segment.

Display an indicator(s) to indicate a position(s) of a return point(s) on the route, where the return point(s) includes the interruption point; when the UAV has a projection point in the interruption segment, the return point(s) includes the projection point of the UAV in the interruption segment; when the UAV has a projection point(s) in the first preset number of spraying segments, the return point(s) includes the projection point(s) of the UAV in the first preset number of spraying segments. It can be understood that the display as mentioned above may include controlling a display device to display.

In some exemplary embodiments, if the UAV has a projection point within the interruption segment and there is a projection point in each segment of a first preset number of spraying segments, the return points include a second preset number of projection points close to the interruption point from a first preset number of projection points. The return points do not include projection points other than the second preset number of projection points within the first preset number of projection points; and/or

If the UAV does not have a projection point within the interruption segment, and there is a projection point on each segment of the first preset number of spraying segments, the return points include all projection points within the first preset number of projection points.

In some exemplary embodiments, when the UAV does not have a projection point within the interruption segment and there are no projection points in each segment within the first preset number of spraying segments, the return points include the starting point of the first spraying segment of the first preset number of spraying segments.

In some exemplary embodiments, if the interruption segment is a spraying segment, the return points include an end point of the interruption segment; and/or

If the interruption segment is a non-spraying segment, the return points include the starting point of the second spraying segment of the first preset number of spraying segments.

In some exemplary embodiments, the first preset number is 2, and the second preset number is 1.

In some exemplary embodiments, the processor 902 is also used for:

Determining the recommended return point from the return points and displaying an indicator to indicate the position of the recommended return point on the flight route.

In some exemplary embodiments, the processor 902 is also used for:

When the UAV has a projection point in the interruption segment, determining the recommended return point from the projection point and the interruption point.

In some exemplary embodiments, the processor 902 is also used for:

Based on the distance between the interruption point and the end point of the interruption segment and the distance between the projection point and the end point of the interruption segment, determining the recommended return point from the projection point and the interruption point.

In some exemplary embodiments, the processor 902 is also used for:
When the distance between the interruption point and the end point of the interruption segment is greater than the distance between the projection point and the end point of the interruption segment and the distance between the projection point and the end point of the interruption segment exceeds a preset threshold, determining the projection point as the recommended return point; and/or
When the distance between the interruption point and the end point of the interruption segment is less than the distance between the projection point and the end point of the interruption segment, determining the interruption point as the recommended return point.

In some exemplary embodiments, when the UAV does not have a projection point within the interruption segment and also does not have a projection point within the first preset number of spraying segments, the return point includes the starting point of the first spraying segment of the first preset number of spraying segments;

The processor 902 is also used for:

Determining the starting point of the first spraying segment as the recommended return point.

In some exemplary embodiments, the processor 902 is also used for:

When the UAV does not have a projection point within the interruption segment and has a projection point within the first preset number of spraying segments, determining the projection point closest to the interruption point among the projection points as the recommended return point.

In some exemplary embodiments, the processor 902 is also used for:
Detecting a return point selection operation by a user, and based on the detected return point selection operation, determining a target return point selected by the user among the return points;
Controlling the UAV to fly to the target return point and continuing the spraying operation along the route from the target return point.

The planning device for spraying operations as shown in FIG. 9 can execute the methods described in the exemplary embodiments shown in FIG. 1-8. For parts not elaborated herein, reference can be made to the relevant descriptions of the exemplary embodiments shown in shown in FIG. 1-8. The execution process and technical effects of this technical solutions can be referred to in the descriptions of the embodiments shown in FIG. 1-8, and will not be repeated herein.

Some exemplary embodiments of the present disclosure further provide a control terminal, which can include a planning device 900 and a display device, as shown in FIG. 10. The control terminal may include: at least one memory/storage medium 901, at least one processor 902, and a display device 903. As mentioned earlier, the at least one memory/storage medium 901 stores executable code, and when the executable code is executed by the at least one processor 902, the at least one processor 902 can implement at least the planning method for spraying operations provided in the exemplary embodiments shown in FIG. 1-8 as described above. The display device 903 is used to display objects that need to be displayed, as mentioned earlier (such as flight routes, indicators, etc.).

Additionally, some exemplary embodiments of the present disclosure also provide a computer-readable storage medium storing executable code for implementing the planning method for spraying operations provided in the various exemplary embodiments described above.

The technical solutions and features in each of the above exemplary embodiments can be implemented separately or in combination, as long as they do not conflict with each other, and are within the cognitive scope of a person skilled in the art, all of which fall within the scope of protection of the present disclosure as equivalent embodiments.

The above-described embodiments are merely exemplary embodiments of the present disclosure and do not limit the scope of the present disclosure thereby. Any equivalent structural or process transformations made using the description and drawings of the present disclosure, or directly or indirectly applied in other relevant technical fields, are also included within the scope of protection of the present disclosure.

Finally, it should be noted that the various exemplary embodiments above are only intended to illustrate the technical solutions of the present disclosure, rather than to limit them. Although detailed explanations of the present disclosure have been provided with reference to the aforementioned exemplary embodiments, a person skilled in the art should understand that the technical solutions described in the aforementioned exemplary embodiments can be modified or equivalently replaces with some or all technical features therein. Such modifications or replacements do not depart from the scope of the technical solutions of the present disclosure.

What is claimed is:

1. A method for operation planning, comprising:
displaying a path of a movable object, wherein the path includes a plurality of segments, and the plurality of segments includes operation segments for the movable object and non-operation segments for the movable object;
determining an interruption position in an interruption segment where the operation of the movable object is interrupted;
determining, based on a position of the movable object, whether the movable object has a projection position corresponding to the position of the movable object in at least one of the interruption segment or each operation segment of a first preset number of operation segments that come after the interruption segment and have not yet been performed with the operation; and
displaying, on the path, indicators indicating return positions for the movable object, wherein the return positions include at least one of the interruption position, or the projection position.

2. The method according to claim 1, wherein upon determining that the movable object has the projection position in the interruption segment and has the projection position in each operation segment of the first preset number of operation segments, the return positions include a second preset number of projection positions, within the first preset number of projection positions, close to the interruption position; or
upon determining that the movable object has no projection position in the interruption segment and has no projection position in each operation segment of the first preset number of operation segments, the return positions include at least one of a starting position of a first operation segment of the first preset number of operation segments or an ending position of the interruption segment.

3. The method according to claim 1, wherein upon determining that the interruption segment is an operation segment, the return positions include an ending position of the interruption segment or a starting position of a first operation segment of the first preset number of operation segments; or
upon determining that the interruption segment is a non-operation segment, the return positions include the starting position of the first operation segment of the first preset number of operation segments.

4. The method according to claim 2, wherein the first preset number is greater than or equal to 2, and the second preset number is 1.

5. The method according to claim 1, further comprising:
determining a recommended return position from the return positions; and
displaying, in a different way, the indicator indicating the recommended return position on the path.

6. The method according to claim 5, wherein the determining of the recommended return position from the return positions includes:
determining the recommended return position from the projection position and the interruption position when the movable object has the projection position in the interruption segment.

7. The method according to claim 6, wherein the determining of the recommended return position from the projection position and the interruption position includes:
determining the recommended return position from the projection position and the interruption position based on a distance between the interruption position and an ending position of the interruption segment and a distance between the projection position and the ending position of the interruption segment.

8. The method according to claim 7, wherein the determining of the recommended return position from the projection position and the interruption position based on the distance between the interruption position and the ending position of the interruption segment and the distance between the projection position and the ending position of the interruption segment includes:
determining the projection position as the recommended return position, when the distance between the interruption position and the ending position of the interruption segment is greater than the distance between the projection position and the ending position of the interruption segment, and the distance between the projection position and the ending position of the interruption segment is greater than a preset threshold; or
determining the interruption position as the recommended return position when the distance between the interruption position and the ending position of the interruption segment is less than the distance between the projection position and the ending position of the interruption segment.

9. The method according to claim 5, wherein the determining of the recommended return position from the return positions includes at least one of the following:
determining a starting position of a first operation segment of the first preset number of operation segments as the recommended return position when the movable object has no projection position in the interruption segment and has no projection position in the first preset number of operation segments; or
determining a projection position closest to the interruption position as the recommended return position when the movable object has no projection position in the interruption segment and has projection positions in the first preset number of operation segments.

10. The method according to claim 1, further comprising:
in response to a selection operation on the return positions by a user, controlling the movable object to move to the return position indicated by the selection operation.

11. The method according to claim 1, further comprising:
performing at least one of updating the return positions according to a preset interval or updating the return positions in response to a position change of the movable object.

12. A device for operation planning, comprising:
at least one storage medium storing at least one set of instructions for operation planning; and
at least one processor in communication with the at least one storage medium, wherein during operation, the at least one processor executes the at least one set of instructions to cause the device to at least:
display a path of a movable object, wherein the path includes a plurality of segments, and the plurality of segments includes operation segments for the movable object and non-operation segments for the movable object,
determine an interruption position in an interruption segment where the operation of the movable object is interrupted,
determine, based on a position of the movable object, whether the movable object has a projection position corresponding to the position of the movable object in at least one of the interruption segment or each operation segment of a first preset number of operation segments that come after the interruption segment and have not yet been performed with the operation, and
display, on the path, indicators indicating return positions for the movable object, wherein the return positions include at least one of the interruption position, or the projection position.

13. The device according to claim 12, wherein upon determining that the movable object has the projection position in the interruption segment and has the projection position in each operation segment of the first preset number of operation segments, the return positions include a second preset number of projection positions, within the first preset number of projection positions, close to the interruption position; or
upon determining that the movable object has no projection position in the interruption segment and has no projection position in each operation segment of the first preset number of operation segments, the return positions include at least one of a starting position of a first operation segment of the first preset number of operation segments or an ending position of the interruption segment.

14. The device according to claim 12, wherein upon determining that the interruption segment is an operation segment, the return positions include an ending position of the interruption segment or a starting position of a first operation segment of the first preset number of operation segments; or
upon determining that the interruption segment is a non-operation segment, the return positions include the starting position of the first operation segment of the first preset number of operation segments.

15. The device according to claim 12, wherein the at least one processor executes the at least one set of instructions to cause the device to further:
determine a recommended return position from the return positions; and
display, in a different way, the indicator indicating the recommended return position on the path.

16. The device according to claim 15, wherein to determine the recommended return position from the return positions, the at least one processor executes the at least one set of instructions to cause the device to at least:
determine the recommended return position from the projection position and the interruption position based on a distance between the interruption position and an ending position of the interruption segment and a distance between the projection position and the ending position of the interruption segment, when the movable object has the projection position in the interruption segment.

17. The device according to claim 16, wherein to determine the recommended return position from the projection position and the interruption position based on the distance between the interruption position and the ending position of the interruption segment and the distance between the projection position and the ending position of the interruption segment, the at least one processor executes the at least one set of instructions to cause the device to at least:
determine the projection position as the recommended return position, when the distance between the interruption position and the ending position of the interruption segment is greater than the distance between the projection position and the ending position of the interruption segment, and the distance between the projection position and the ending position of the interruption segment is greater than a preset threshold; or
determine the interruption position as the recommended return position when the distance between the interruption position and the ending position of the interruption segment is less than the distance between the projection position and the ending position of the interruption segment.

18. The device according to claim 15, wherein to determine the recommended return position from the return positions, the at least one processor executes the at least one set of instructions to cause the device to perform at least one of the following:
determining a starting position of a first operation segment of the first preset number of operation segments as the recommended return position when the movable object has no projection position in the interruption segment and has no projection position in the first preset number of operation segments; or
determining a projection position closest to the interruption position as the recommended return position when the movable object has no projection position in the interruption segment and has projection positions in the first preset number of operation segments.

19. The device according to claim 12, wherein the at least one processor executes the at least one set of instructions to cause the device to further:
In response to a selection operation on the return positions by a user, control the movable object to move to the return position indicated by the selection operation.

20. The device according to claim 12, wherein the at least one processor executes the at least one set of instructions to cause the device to further:
perform at least one of updating the return positions according to a preset interval or updating the return positions in response to a position change of the movable object.
